(19) United States
(12) Patent Application Publication
(10) Pub. No.: US 2009/0244648 A1
(43) Pub. Date: Oct. 1, 2009

(54) Mouse Scanner Position Display

(76) Inventors: Kenny Chan, Foster City, CA (US); Isao Hayami, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/060,208

(22) Filed: Mar. 31, 2008

(51) Int. Cl. H04N 1/024

(52) U.S. Cl. 358/473

(57) ABSTRACT

A method for providing a visual representation pertaining to a resolution of at least one scanned image segment obtained from a portable scanner is disclosed. The method includes associating the scanned image segment with positional coordinates relative to an image on a scanned medium. The method also includes determining the resolution of the scanned image segment and assigning the scanned image segment to a resolution category associated with the resolution. The method also includes displaying the image segment in a format associated with the resolution category, at a location corresponding to the location of the image segment relative to the image on the scanned medium.

### FIELD OF THE INVENTION

The present invention relates to systems and methods for capturing image data and providing real time feedback relating to the resolution of the captured image data.

### DESCRIPTION OF RELATED ART

Scanners are often used to create electronic representations of physical items, such as documents. Such electronic representations may be in the form of electronic images, which can be reproduced and transmitted with ease. There are many different types of scanners, including flatbed scanners and portable scanners. Flatbed scanners are relatively fast and well-suited for standard scanning jobs from standard size paper sheets. Portable scanners offer flexibility and the ability to scan images from a variety of media types and sizes.

Portable scanners often operate by moving over the item being scanned, and gathering image data pertaining to the item. Subject to device limitations, in portable scanners, scan resolution is inversely proportional to the speed of movement. Therefore, subject to its maximum scan resolution, slower movement on the part of a portable scanner may translate to more image data and a higher scan resolution.

Typically, because of operational constraints, portable scanners, such as handheld scanners, move at varying speeds. For example, a user operating a handheld scanner may move the handheld scanner slowly over a first part of the item, and then move the handheld scanner more quickly over a second part of the item. In this scenario, the image data corresponding to the first part of the item may have a higher resolution than the image data corresponding to the second part of the item. In some cases, the resolution of image data captured by a portable scanner during a scan may not be acceptable. For example, resolutions below a minimum threshold may yield poor image quality. In other instances, an application using the scanned data may demand a minimum scan resolution. For example, Optical Character Recognition (“OCR”) algorithms may not be able to operate if the image quality is poor.

If some portion of the image data has an unacceptable resolution, the user may rescan all, or the affected portions of the item. Typically, users can determine that image data resolution is poor when the image is uploaded to a computer for viewing and analysis. However, because a user may be using the portable scanner without a computer, the user may not be able to determine whether the image data has acceptable resolution, while the user still has access to the item. Because of the lack of real time feedback, the user may realize that the resolution of the image data is not acceptable, at a time when the user no longer has access to the item for rescanning. Therefore, there is a need for apparatus, systems, and methods that permit users to make determinations dynamically about the quality of scanned data, without having to upload the image data to the computer.

### SUMMARY OF THE INVENTION

In accordance with, disclosed embodiments, a method for providing a visual representation pertaining to a resolution of at least one scanned image segment obtained from a portable scanner, the method comprising: associating the scanned image segment with positional coordinates relative to an image on a scanned medium; determining the resolution of the scanned image segment; assigning the scanned image segment to a resolution category associated with the resolution; and displaying the image segment in a format associated with the resolution category, at a location corresponding to the location of the image segment relative to the image on the scanned medium.

Embodiments also pertain to programs on computer-readable media, apparatus, and systems for providing a visual representation pertaining to the resolution of scanned images to users. Additional advantages of the present invention will be set forth in part in the description, which follows, and in part will be obvious from the description, or may be learned by practice of the invention. The advantages of the invention will be realized and attained by means of the features and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the present invention and together with the description, serve to explain the principles of the invention.

### BRIEF DESCRIPTION OF THE DRAWINGS

FIG. 1 shows a block diagram of an exemplary system for use with a portable scanner;

FIG. 2 shows a block diagram of an exemplary portable scanner;

FIG. 3 is a flowchart illustrating a process of receiving, processing, and displaying image data;

FIG. 4 is a flowchart illustrating a process of formatting a current image into a display image, and sending the display image to a display;

FIG. 5 is diagram illustrating a design of a portable scanner; and

FIG. 6 is a flowchart illustrating an iteration of an exemplary process of operation of the portable scanner.

### DESCRIPTION OF THE EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

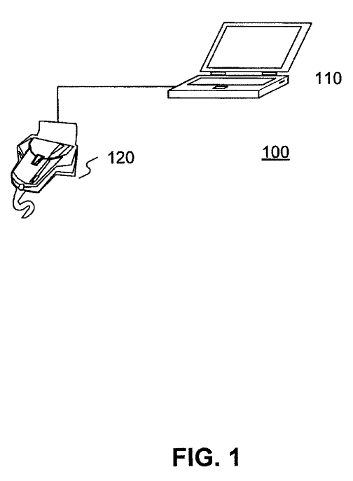

FIG. 1 is a block diagram of an exemplary system for use with a portable scanner. In some embodiments, system 100 can include computing device 110 and portable scanner 1020. Computing device 110 may be a computer workstation, desktop computer, laptop computer, or any other computing device. Portable scanner 120 may be a handheld scanner capable of scanning documents. Computing device 110 may include software for controlling and configuring portable scanner 120. Portable scanners 120 may connect to computing device 110 using wired or wireless connections.

Portable scanner 120 may include volatile and nonvolatile memory, as well as an interface for removable storage media. Portable scanners 120 may also have ports such as USB and/or serial ports to facilitate connection to computing devices 110. In some embodiments, the connection between portable scanners 120 and computing devices 110 may be wireless.

Computing device 110 may include volatile and nonvolatile memory and may also include data storage such as one or more hard disks. Computing device 110 may also include at least one interface for removable storage media, for example, 3.5 inch floppy drives, CD-ROM drives, DVD ROM drives, CD±RW, or DVD±RW drives, and/or any other removable storage drives consistent with disclosed embodiments. In some embodiments, portions of a software application may reside on removable media and be read and executed by computing device 110 or portable scanner 120.

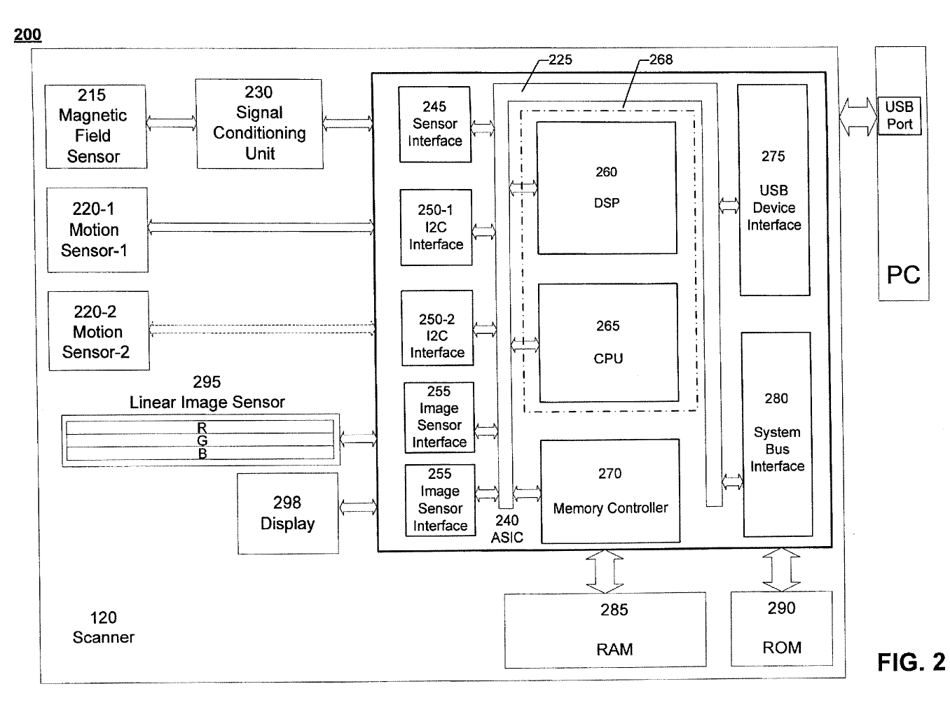

FIG. 2 depicts a block diagram 200 of an exemplary portable scanner 120. The embodiment in FIG. 2 is exemplary and for illustrative purposes only and various other implementations would be apparent to one of ordinary skill in the art. Exemplary portable scanner 120 may include motion sensors 220, magnetic field sensor 215, linear image sensors 295, and memory, including one or more of Random Access Memory (“RAM”) 285 and/or Read Only Memory (“ROM”) 290. Exemplary portable scanner 120 may also include an Application Specific Integrated Circuit (“ASIC”) 240, which can process signals received from motion sensors 220, linear image sensors 295, and from magnetic field sensor 215 through Signal Conditioning Unit 230. In some embodiments, a Field Programmable Gate Array (“FPGA”), logic, multiple chips and/or other circuitry may be used in lieu of, or in addition to ASIC 240. In some embodiments, exemplary ASIC 240 may consist of multiple chiplets or functional blocks such as sensor interface 245, I2C interfaces 250-1 and 250-2, Processor 268, memory controller 270, Universal Serial Bus (“USB”) Device Interface 275, System Bus 225, and System Bus Interface 280.

In general, Processor 268 may comprise of some combination of appropriately coupled CPUs 265 and/or DSPs 260. For example, Processor 268 may comprise CPU 265 coupled to Digital Signal Processor (“DSP”) 260, as shown in FIG. 2. Various other combinations of CPUs and/or DSP are also possible.

In one embodiment, magnetic field sensor 215 may comprise of multiple sensor elements for measuring the x- and y-components of the earth's magnetic field in the horizontal plane. For example, magnetic field sensor 215 can include two 2-dimensional field sensors oriented at 90 degrees relative to each other. In some embodiments, magnetic sensor 215 may take advantage of magnetoresistive effects based on characteristics of the earth's magnetic field or other known external magnetic fields to measure the orientation of portable scanner 120 relative to an image or scanned item. The magnetoresistive effect refers to the property of a current carrying magnetic material to change its resistance in the presence of an external magnetic field. In general, any magnetic field that is constant over the scan area may be used.

Exemplary sensor interface 245 can receive signals from magnetic field sensor 215, which can be conditioned by signal conditioning unit 230 to remove noise and other unwanted interference and to convert the signal to an appropriate digital format capable of being processed by sensor interface 245 in ASIC 240. In one embodiment, exemplary signal conditioning unit 230 may be capable of direction determination using inputs provided by magnetic field sensor 215. For example, in an embodiment in which magnetic field sensor 215 uses two sensor elements, magnetic field sensor 215 may generate two voltages proportional to each sensor element's output. The voltages may be converted to digital values and CPU 265 may calculate the actual angle from these digital values. Exemplary sensory interface 245 can communicate with signal conditioning unit 230 and place any signals received from signal conditioning unit 230 on system bus 225. In some embodiments, magnetic field sensor 215 and signal conditioning unit 230 may be packaged as a single integrated circuit.

Exemplary system bus 225 acts as a conduit for data, signals, and/or commands on ASIC 240 and facilitates communication and data sharing between various functional blocks on ASIC 240, which may operate under the control of CPU 265. For example, CPU 265 may retrieve data from RAM 285 through memory controller 270 by placing an appropriate command and/or address information on system bus 225. The command and address may be used by memory controller 270 to retrieve data from RAM 285, which can be placed on system bus 225 for use by CPU 265. RAM 285 may be any type of memory capable of being accessed by memory controller 270, including SDRAM, RDRAM, or DDR RAM memory modules.

In some embodiments, signals produced by exemplary motion sensors 220-1 and 220-2 may travel over buses such as Inter Integrated Circuit (I²C) buses to I²C interface 250-1 and 250-2, respectively. The use of I²C buses is exemplary only and other types of buses may be used convey sensor data from exemplary motion sensors 220-1 and 220-2 to the appropriate bus interface on ASIC 240. In one embodiment, motion sensors 220-1 and 220-2 and linear image sensor 295 may sample image related data at fixed intervals. In a device with two motion-sensors, such as portable scanner 120 with motion sensors 220-1 and 220-2, raw motion sensor data may consists of two 16-bit values, which can represent changes to the X and Y co-ordinates from the immediately prior reading of motion sensors 220-1 and 220-2.

Exemplary linear image sensor 295 can utilize Charge Coupled Device (“CCD”) or Complementary Metal Oxide Semiconductor (“CMOS”) sensor technology. In some embodiments, linear image sensor 295 may consist of three sensor arrays for Red (R), Blue (B), and Green (G) color spaces, respectively. The image signals from linear image sensor 295 may be transferred to image sensor interface 255, which can be made up of A/D converters for R, G, and B signals, and other image conditioning means. A/D converters can generate R, G, and B image data from of R, G, and B image signals, respectively, in accordance with amplitude and/or other parameters of each image signal. In some embodiments, position correlation data from motion sensors 220-1 and 220-2, such as (x, y) co-ordinate data, and/or information pertaining to the orientation of portable scanner 120 provided by magnetic field sensor 215 can be stored along with image data for image segments captured by linear image sensor 295. In some embodiments, resolution data of image segments captured by linear image sensor 295 may also be stored with image segments and displayed in some format using display 298. In some embodiments, co-ordinates of the region bounded by the image segment may stored in memory and correlated with image segments. In some embodiments, linear image sensor 295 may not include sensor arrays for color spaces, and may instead collect grayscale data.

An image segment, as used herein, may be sample of image data collected by portable scanner 120 over a time period. The image segment may correspond to a section of the scanned item. The time period may be used to define the image segment. In some embodiments, the time period may be static or variable. In some embodiments the nature of the time period may be configurable. One of ordinary skill in the art will recognize that there may be other approaches to obtaining image segments that may depend on the application.

Data from linear image sensor 295, motion sensors 220-1 and 220-2, and magnetic sensor 215 can be used to generate a complete image of the scanned object from image segments by stitching the image segments generated during sweeps together. For example, if more than one pass is used to scan an object, then position correlation data provided by motion sensors 220 can be used to stitch the image segments together to form an image of the scanned item. Image data from linear image sensor 295 can be transferred to RAM 285 in for storage in an appropriate data format. For example, image data may be stored in RAM 185 as 24-bit or 36-bit pixels of RGB data.

Exemplary CPU 265 can receive information captured by sensors in exemplary portable scanner 120 through system bus 225. CPU 265 may also monitor and synchronize the operations of input and output ports on portable scanner 120 with other device elements. For example, CPU 265 can identify the number of endpoints and the various types of USB endpoints using USB Device Interface 275 and coupled computing device 110. CPU 265 may monitor, reset, initialize, and control any user panels and/or display on portable scanner 120. Further, CPU 265 can reset and/or initialize one or more sensors when portable scanner 120 is powered on. In some embodiments, CPU 265 may set sensitivity and/or other parameters for one or more sensors based on user input or directions received from coupled computing device 110 through the appropriate sensor interface. For example, CPU 265 may issue commands over System Bus 225 to image sensor Interface 255 that cause a default profile for linear image sensor 295 to be loaded.

Exemplary CPU 265 can accept commands received from a user or from coupled exemplary computing device 110. For example, CPU 265 may wait for a “start” command from the user to commence scanning operations. In some embodiments, start may be indicated by the user, by pushing down on a scan activation button on the scanner. Image data and positional correlation information acquired by the various sensors from scanning operations in portable scanner 175 can be sent to or retrieved by CPU 265 through the appropriate sensor interface and System Bus 225. Exemplary CPU 265 can then place image data and associated positional correlation information in RAM 285. In some embodiments, positional correlation information may include positional co-ordinates and information pertaining to scanner orientation relative to the object being scanned. In some embodiments, the user may be asked to provide an indication of the top left corner of the image or page being scanned so that co-ordinates may be generated relative to the top left corner.

CPU 265 may also detect and monitor events pertaining to motion sensors 220-1 and 220-2. For example, CPU 265 may detect when motion sensors 220-1 and 220-2 start and/or stop providing positional correlation information. For example, motion sensors 220-1 and 220-2 may not be able to provide positional correlation information if the distance between portable scanner 120 and the scanned object exceeds their sensory threshold. For example, motion sensors 220 may cease to provide valid data when they are at a perpendicular distance 10 mm or greater from the medium being scanned. In such situations, exemplary magnetic field sensor 215 and associated signal conditioning unit 230 can provide information about the orientation of portable scanner 120 relative to the scanning medium to CPU 265. In some embodiments, the orientation information generated by magnetic sensor 215 can supplement data provided by the motion sensors 220-1 and 220-2.

In some embodiments, orientation information generated by magnetic sensor 215 can be used when portable scanner 120 is lifted off the medium being scanned such as when the user repositions portable scanner 120 for another sweep across the page. In such a situation, motion sensors 220-1 and 220-2 may be temporarily unable to provide sensory information because the distance of the scanner from the scanning medium may exceed their sensory threshold. CPU 265 may detect when motion sensors 220-1 and 220-2 stop providing positional correlation information.

When portable scanner 120 is returned to the page, data from the magnetic image sensor can be used to provide an “angle correction factor” that is applied to the new set of position data associated with the new sweep of the sensor across the page by the user. CPU 265 may detect when motion sensors 220-1 and 220-2 start providing positional correlation information corresponding to the new sweep. In some embodiments, information from magnetic sensor 215 may be used when information from motion sensors 220-1 and 220-2 is unavailable or unreliable.

In some embodiments, CPU 265 may initialize and control DSP 260. For example, CPU 265 may configure DSP 260 to process image segments. In one instance, DSP 260 may be configured to align the image segments. For example, DSP 260 may rotate the image segments to a common orientation to facilitate a subsequent image segment stitching process. For example, all image segments may be rotated so that they are aligned to a horizontal. In some embodiments, DSP 260 may perform its functions in parallel with image scanning activity performed by portable scanner 120. In some embodiments, DSP 260 may include multiple cores, which may be able to operate in parallel on multiple sets of pixels corresponding to different image segments. In some embodiments, CPU 265 may provide information pertaining to one or more stored image segments to DSP 260. For example, such information can include memory addresses of individual image segments, image segment size, image segment position and orientation information, the type of processing desired, and information on where results may be stored after processing by DSP 260.

In some embodiments, CPU 265 may also configure DSP 260 to examine aligned image segments in memory to detect segment boundaries, identify overlapping regions in the segments, and assemble a complete image of the scanned object. In one embodiment, DSP 260 may run pattern matching algorithm on image segments in parallel with the scanning of other image segments. For example, DSP 260 may be configured to identify overlapping areas of image segments after alignment so that the individual segments can be stitched together to form a complete image of the scanned object. Stitching refers to the process of combining one or more distinct image segments with overlapping regions into a new larger image segment that incorporates information in the original segments without duplication. Overlapping regions can be used as indicators of adjacent segments. In some embodiments, pattern matching algorithms may be used to identify overlapping regions in image segments.

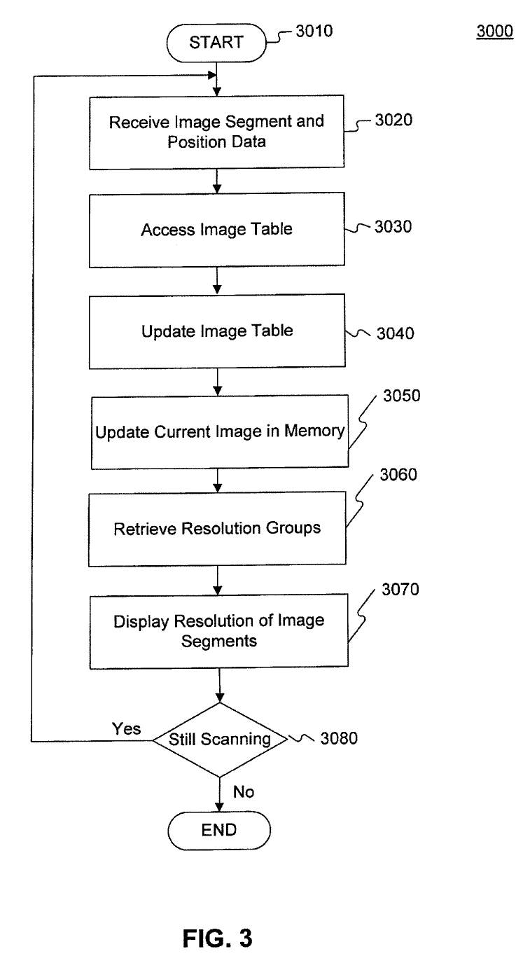

FIG. 3 shows exemplary flowchart 3000, which describes a method of capturing and processing image data in portable scanner 120. The process begins at step 3010. At step 3020, an image segment and position data may be received. For example, image capture sensor may collect the image segment and send the image segment to CPU 265 via image sensor interface 255. Furthermore, motion sensor 220 and magnetic field sensor 215 may collect position and/or orientation data and send the information to CPU 265 via sensor interface 245 and I²C interface 250, respectively. Position data may include position coordinates, such as x- and y-coordinates, or a change in position coordinates. CPU 265 may generate scan speed data using the position data and timing information. Each scanned segment may be assigned a unique identifier that is different from the identifier assigned to other segments. In some embodiments, a timestamp may be used to identify each image segment.

At step 3030, an image table may be accessed. For example, CPU 265 may access the image table to store the co-ordinates or bounds of the current image segment, i.e. the image segment that was most recently scanned. The image table may include a list of image segments along with scan speed data, position data, memory address information to locate the image segment data in RAM 285, and resolution data for each listed image segment. In some embodiments, the image table lists the segments that form the currently held memory image of the scanned object in RAM 285. The current image may be a partial or incomplete representation of the scanned item and may be composed, in part, from previous image segments that have been stitched together. The current image may be a representation of image data collected thus far.

At step 3040, the image table may be updated. For example, CPU 265 may update the image table by creating a new entry for the incoming image segment. In some embodiments, CPU 265 may store the image data in RAM 285 along with position data, resolution information and/or scan speed data corresponding to the incoming image segment. CPU 26 may then update the new entry in the image table corresponding to the image segment with the memory address or memory address range the holds data for the image segment. Position data provided by the motion sensors may be used to place the segment relative to the image on a scanned medium. These positional co-ordinates, which may be (x, y) co-ordinates may be used to bound the scanned image segment. For example, the (x, y) co-ordinates of the four corners of the image segment may be used to identify the range of the image segment.

In some embodiments, the processing of image segments may be performed in parallel with the image scanning process, for example using DSP 260. In some embodiments, a pattern matching algorithm may be used to assemble the image segments in memory, for example using DSP 260. In some embodiments, when the image segment is stitched into a pre-existing memory image, address and other location information for the segment may be updated in the image table. For example, DSP 260 may provide new segment address or address range information to CPU 265 after a successful image stitching run. CPU 265 may then update the image table entry for the image segment with the new information.

In some embodiments, CPU 265 may be able to use position data associated with an image segment to determine that a partially or fully overlapping image segment already exists in the image table. In such situations, CPU may compare the resolution of the current segment with the pre-existing segment and retain the higher resolution data. For example, if the currently scanned image segment B overlaps fully with a pre-existing image segment A and has a higher resolution than image segment A, then the entry for A in the image table may be replaced with the entry for B. Actual image data in RAM 285 corresponding to image segment A, will also be updated with the data for B. If there is a partial overlap of segments A and B, then the co-ordinates for image segment A may be updated in the image table to remove the segment from A and assign the region to B. Actual image data in RAM 285 may also be updated accordingly.

At step 3060, resolution categories may be loaded. For example CPU 265 may load resolution categories. The resolution categories may be defined in terms of scan speed data. In some embodiments, the resolution categories are defined by a range of scan speeds, including a minimum scan speed and a maximum scan speed. In some embodiments, each resolution category may have a visually different format for display. Formatting can include grayscale shading, hatching, patterns, textures, color, the actual image data itself, and/or any other type of visually distinguishable formatting. In some embodiments, the type of formatting may be user-selectable. In some embodiments, a special pattern may be used to indicate that the scanned data is below an acceptable threshold of image resolution. In some embodiments, the acceptable threshold may be user-configurable.

At step 3070, image segments may be displayed on display 298. For example CPU 265 may display the image segments on display 298. In some embodiments, CPU 265 iterates through the image table. For each image segment in the image table, CPU 265 may determine a location in which to place the selected image segment on display 298 using the position data, and may determine a resolution category for the image segment using the scan speed data for that image segment. CPU 265 may then display each image segment at an appropriate location on the display 298 in a format consistent with the resolution category for the image segment. At step 3080, the process checks to see if the portable scanner is still scanning. If the portable scanner is still scanning, then the algorithm iterates through steps 3020 to 3070. If not, then the process ends at step 3080.

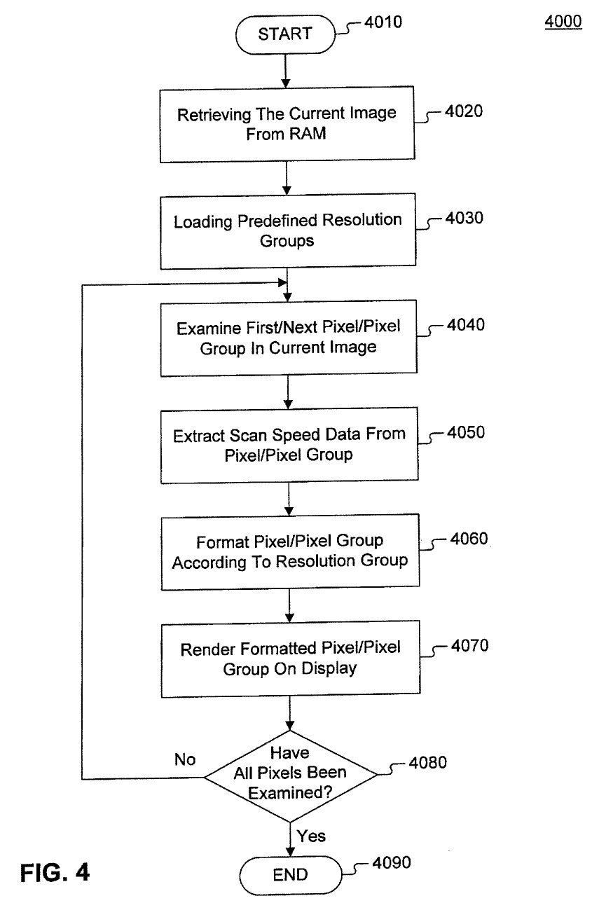

FIG. 4 shows flowchart 4000, which describes an alternate embodiment of processing image data to provide a visual representation of the scanned data. In some embodiments, the visual representation of the scanned data may include image data instead of resolution data. The process starts at step 4010. At step 4020, the current image may be retrieved. For example, CPU 265 may retrieve the current image from RAM 285. The current image may comprise image data describing pixels or groups of pixels in a particular order for display. The current image may also include associated scan speed and resolution data for one or more pixels, or for groups of pixels. The scan speed data may describe a rate at which portable scanner moves while gathering the image data corresponding to each pixel, or group of pixels.

At step 4030, the resolution categories may be loaded. For example CPU 265 may load resolution categories, and associate the pixels or groups of pixels with a resolution category according to the scan speed data of the pixels or pixel groups. In some embodiments, pixels may be categorized based on their scan speed into various groups. A resolution group may comprise pixels that were scanned in at between the minimum and maximum threshold scan speed values for that group. Pixels or groups of pixels that were gathered at a scan speed can be assigned to an appropriate resolution group, if the scan speed of the pixels is in the range of minimum through maximum threshold scan speed values for that group.

At step 4040, a first pixel or pixel group in the current image may be examined. At step 4050, scan speed data is extracted from the examined pixel or pixel group. In some embodiments, the scan speed data may be located outside of the current image, for example in an image table. For an examined pixel group, CPU 265 may calculate an aggregated scan speed data from a plurality of scan speed data values associated with the examined pixel group (i.e. for each pixel or sub-group within the pixel group). In some embodiments, CPU 265 may calculate the mean, mode, or median value of the plurality of scan speed values associated with the examined pixel group to calculate the aggregated scan speed data.

At step 4060, the pixel or pixel group may be assigned to a resolution category group depending on the scan speed data. For example CPU 265 may assign the pixel or pixel group to a resolution category and may format the pixel or pixel group according to the formatting associated with the resolution category. At step 4070, the formatted pixel or pixel group may be rendered on the display 298, for example using CPU 265. In other embodiments, CPU 265 may first format and save the formatted versions of pixel or pixel groups before rendering them.

At step 4080, the algorithm determines whether or not it has finished examining all pixels or pixel groups. If not, then the process iterates through step 4040 through 4080. If so, then the process ends at step 4090.

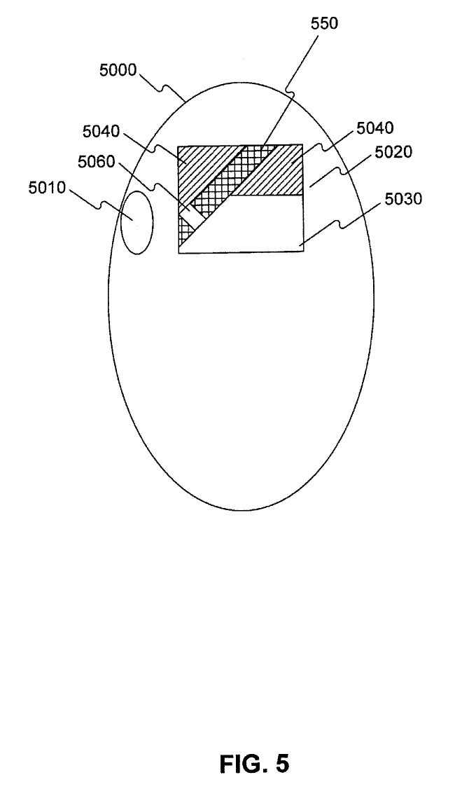

FIG. 5 illustrates an exemplary display on portable scanner 5000. In some embodiments, portable scanner 5000 may take the form of a computer mouse, or a form that is easily manipulated by hand. Portable scanner 5000 may include scan activation button 5010 for initiating a scan. In some embodiments, scan activation button 5010 is held continuously while scanning. In other embodiments scan activation button 5010 is pressed to begin a scan and pressed again to end a scan.

Portable scanner 5000 may also include display 5020 for simulating the item being scanned, for example, a document page. Display 5020 includes a first portion 5030 in a first format that indicates a part of the item that has yet to be scanned. In addition, different portions of display 5020 may also correspond to different resolution groups or scan speed groups. For example, display 5020 includes a second portion 5040 in a second format that indicates a part of the item that was scanned at a low resolution. Display 5020 includes a third portion 5050 in a third format that may indicate a part of the image that was scanned at a different resolution. Display 5020 may include a number of portions indicating a number of resolution categories in a number of different formats.

In some embodiments, Display 5020 may also include a fourth portion 5060 in a fourth format that indicates a relative location of the portable scanner 5000 with respect to the item being scanned. In some embodiments, the fourth format may be a cursor. Portable scanner 5000 may keep track of its position with respect to the item being scanned using the position data. Portable scanner 5000 may periodically update the relative location during the scanning. In one embodiment, it is assumed that the user orients the scanner to the upper left edge of the paper and continues on a left to right and right to left sweep, incrementally moving the portable scanner 5060 toward the bottom of the item without lifting the portable scanner 5060. Using this assumption, portable scanner 5000 may use the position data to keep track of its position. In another embodiment, the user may be allowed to provide input to determine the location of the scanner.

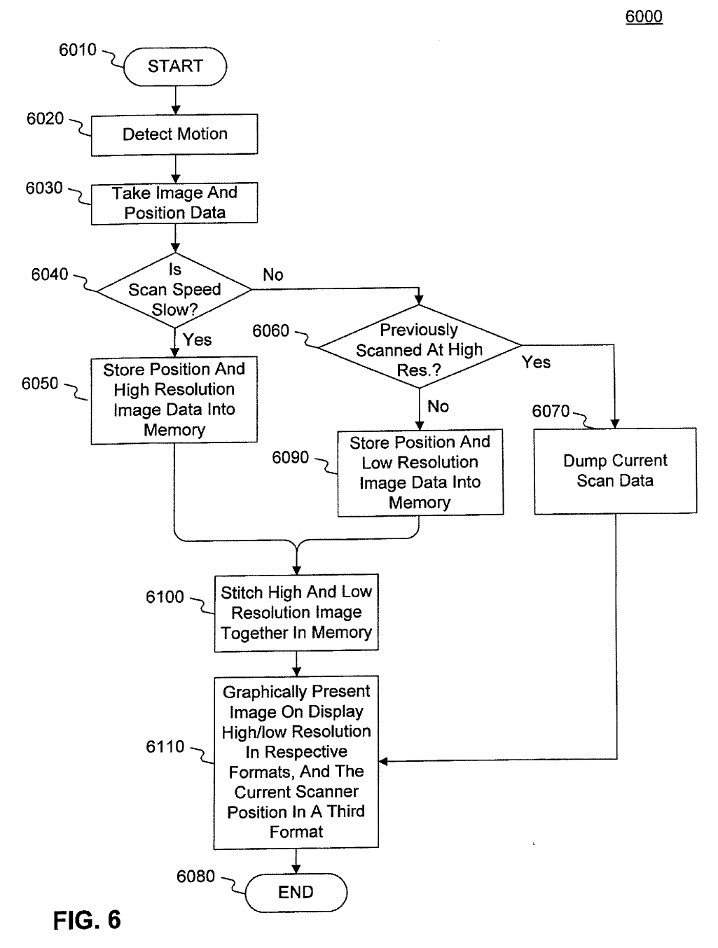

FIG. 6 shows flowchart 6000, which describes an iteration of exemplary process of operation of the portable scanner to provide real time feedback. The iteration begins at step 6010. At step 6020, motion is detected. For example motion sensor 220 may detect motion. At step 6030, image and position data can be captured. For example, linear display sensor 295 may capture image data, and motion sensor 220 and magnetic field sensor 215 may capture position data. As step 6040 it is determined whether or not the scan speed was slow. For example, CPU 265 may use position data and timing information to determine scan speed. If the scan speed was slow, yielding high resolution image data, the process moves to step 6050 and stores the position and high resolution image data into memory. Alternatively, if the scan speed was not slow, yielding low resolution image data, the process moves to step 6060 and checks to see if the same area was previously scanned at a slow speed (i.e. high resolution.) If the same area was previously scanned at a high resolution the process discards the low resolution data at step 6070. The process then proceeds to step 6110 to update the display. In some embodiments, the new position of the cursor may be updated even if there are no updates to other parts of the display. On the other hand, if the same area was not previously scanned at high resolution, the process stores the low resolution image data and position information in memory at step 6090.

At step 6100, the scanner stitches together the high and low resolution image information in memory. At step 6110, the scanner displays the image with the high resolution portion of the image, the low resolution portion of the image, and the cursor position in different formats. In some embodiments, a pattern matching algorithm may be used to assemble the image segments in memory. For example, overlapping areas of image segments may be identified after the image segments have been aligned to an axis to facilitate the image segment stitching process. The presence of overlapping regions can be used as an indication that the segments are adjacent.

In some embodiments, processor 265 may determine a best fit for the image in a frame after the image stitching process. In other embodiments, a pre-determined image segment may be used as an anchor during the image segment stitching process. For example, the scanning process may be designed so that the user provides an indication when a scan begins at the top left corner of an image or page being scanned. The top left image segment may then be used as an anchor to tie the other scanned image segments together. The iteration then ends at step 6080.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing a visual representation pertaining to a resolution of at least one scanned image segment obtained from a portable scanner, the method comprising:
associating the scanned image segment with positional coordinates relative to an image on a scanned medium;
determining the resolution of the scanned image segment;
assigning the scanned image segment to a resolution category associated with the resolution; and
displaying the image segment in a format associated with the resolution category, at a location corresponding to the location of the image segment relative to the image on the scanned medium.

2. The method of claim 1, further comprising:
displaying a cursor indicating the current location of the portable scanner relative to the image on the scanned medium.

3. The method of claim 1, wherein the display is located on the scanner.

4. The method of claim 1, further comprising:
displaying an unscanned area of the image on the scanned medium in a visually distinguishable format.

5. The method of claim 1, wherein the resolution of the scanned image segment is determined based on scan speed.

6. The method of claim 1, wherein assigning the scanned image segment to a resolution category associated with the resolution further comprises:
determining that the scanned image segment is below an acceptable resolution threshold; and
displaying the image segment according to a visually distinguishable format associated with image segments that are below the acceptable resolution threshold.

7. The method of claim 6, wherein the image segment is displayed by flashing the visually distinguishable format associated with image segments that are below the acceptable resolution threshold on the display.

8. The method of claim 1, wherein the formats associated with resolution categories are user selectable.

9. A computer-readable medium including program instructions, which, when executed by a processor, cause the processor to perform a method for providing a visual representation pertaining to a resolution of at least one scanned image segment obtained from a portable scanner, the method comprising:
associating the scanned image segment with positional coordinates relative to an image on a scanned medium;
determining the resolution of the scanned image segment;
assigning the scanned image segment to a resolution category associated with the resolution; and
displaying the image segment in a format associated with the resolution category, at a location corresponding to the location of the image segment relative to the image on the scanned medium.

10. The computer-readable medium of claim 9, further comprising:
displaying a cursor indicating the current location of the portable scanner relative to the image on the scanned medium.

11. The computer-readable medium of claim 9, wherein the display is located on the scanner.

12. The computer-readable medium of claim 9, further comprising:
displaying an unscanned area of the image on the scanned medium in a visually distinguishable format.

13. The computer-readable medium of claim 9, wherein the resolution of the scanned image segment is determined based on scan speed.

14. The computer-readable medium of claim 9, wherein assigning the scanned image segment to a resolution category associated with the resolution further comprises:
determining that the scanned image segment is below an acceptable resolution threshold; and
displaying the image segment according to a visually distinguishable format associated with image segments that are below the acceptable resolution threshold.

15. The computer-readable medium of claim 14, wherein the image segment is displayed by flashing the visually distinguishable format associated with image segments that are below the acceptable resolution threshold on the display.

16. The computer-readable medium of claim 9, wherein the formats associated with resolution categories are user selectable.

17. A portable scanner, comprising:
an input interface for receiving an image segment and positional coordinates relative to an image on a scanned medium;
a storage device for storing the image segment, position coordinates, and instructions for providing a visual representation pertaining to a resolution of the scanned image segment; and
a processor coupled to the input interface and the storage device, wherein the processor executes the instructions to perform the steps of:
associating the scanned image segment with the positional coordinates;
determining the resolution of the scanned image segment;
assigning the scanned image segment to a resolution category associated with the resolution; and
displaying the image segment in a format associated with the resolution category, at a location corresponding to the location of the image segment relative to the image on the scanned medium.

18. The portable scanner of claim 17, wherein the processor executes the instructions to perform the step of:
displaying a cursor indicating the current location of the portable scanner relative to the image on the scanned medium.

19. The portable scanner of claim 17, wherein the display is located on the scanner.

20. The portable scanner of claim 17, wherein the processor executes the instructions to perform the step of:
displaying an unscanned area of the image on the scanned medium in a visually distinguishable format.

21. The portable scanner of claim 17, wherein the resolution of the scanned image segment is determined based on scan speed.

22. The portable scanner of claim 17, wherein assigning the scanned image segment to a resolution category associated with the resolution further comprises:
determining that the scanned image segment is below an acceptable resolution threshold; and
displaying the image segment according to a visually distinguishable format associated with image segments that are below the acceptable resolution threshold.

23. The portable scanner of claim 22, wherein the image segment is displayed by flashing the visually distinguishable format associated with image segments that are below the acceptable resolution threshold on the display.

24. The portable scanner of claim 17, wherein the formats associated with resolution categories are user selectable.
